(19) United States
(12) Patent Application Publication
(10) Pub. No.: US 2025/0242880 A1
(43) Pub. Date: Jul. 31, 2025

(54) Scooter Ergo Stabilization Platform

(71) Applicant: GOSCOOTIN INC, Cle Elum, WA (US)

(72) Inventors: Jeffrey J. Brackus, Meridian, ID (US); David Joseph Darling, Purcell, OK (US)

(21) Appl. No.: 19/038,315

(22) Filed: Jan. 27, 2025

Related U.S. Application Data
(60) Provisional application No. 63/625,114, filed on Jan. 25, 2024.

(51) Int. Cl. B62K 13/06; B62K 5/00; B62K 5/01; B62K 19/20; B62K 19/22

(52) U.S. Cl. CPC B62K 13/06; B62K 5/01; B62K 2005/001; B62K 19/20; B62K 19/22; B62K 2202/00

(57) ABSTRACT

An added platform that attaches to a Scooter for purposes of ergonomics, maneuverability, security, and comfort. The device utilizes a clamping system for the purpose of attaching an ergo stability platform to an existing E-Scooter or standard Scooter. The Scooter attachment is configured with wheel(s) and a clamping mechanism, either removable or affixed, that is positioned and configured on the Scooter to enhance security for the rider who might need these amenities. The Scooter attachment may come in any geometric design and is scaled larger than the substrate of the Scooter. The Scooter attachment may be attached to Scooter via glue, weld, sonic welded, or bolt with any clamping device. The Scooter attachment is configured with a guide slot(s) on the platform to receive the seat base. The mechanism that attaches these two embodiments together, may be clamped, bolted, glued, or welded. The Scooter attachment is also configured to include wheel(s) attached thereto. The wheels are to hold upright the Scooter and Rider.

### TECHNICAL FIELD

The presently disclosed technology relates to Scooters, including Electric (E) Scooters. More particularly, the present invention is a device with an additive platform that adheres to an E Scooter, or any type of Scooter.

### BACKGROUND

Scooters typically include two wheels and a platform extending between the wheels. The scooter platform serves the purpose of providing a small standing area for the user. Scooters have been around for decades and have not evolved too much through the years. Manual scooters are accelerated by a rider using a leg to push the Scooter along a pathway. The electric Scooter has only been around for a while relative to the manual Scooter. Electric or E-scooters us a small electric motor to drive one or both wheels of the scooter.

All Scooters have a fixed structure between the front and back wheel. The structure of the E (Electric) Scooter is the most common Scooter today. The structure, or substrate is now the battery/platform and is a fixed structure for power and standability. The permanent platform comes in different geometric shapes and fits between the front and back wheel. The permanent platform or structure can be round, contoured, rectangular, or any geometric design the manufacturer deems necessary for sound structure, or cosmetically appealing to the eye.

Highly skilled Scooter operators are capable of maneuvers, balance, stamina, and confidence while in use. However, the user who does not possess the above-mentioned skills, may be at a disadvantage in this situation.

A plethora of E Scooters and Manual Scooters exist that vary in function and operation. A user skilled in balance and maneuverability, can access and ride the Scooter without any issues of platform area or balance. Usually, a young, more athletic individual can perform highly integral maneuvers, and does not require a large platform to stand on. The current platforms are smaller in design and offer no enhanced platform to enhance balance for the user.

The Scooter platform is between the front and back wheel, and within a perimeter of the wheels, the platform is a non-battery, or a battery substrate. The user of the E-Scooter steps on the platform and activates the electric motor to accelerate the Scooter/user forward, but not limited to, a manual, electric, or any other potential kinetic accelerator. The scooter platform is typically narrow, and is not forgiving to users with lower balance attributes or coordination.

### SUMMARY OF THE DISCLOSURE

The purpose of the Summary is to enable the public, and especially the scientists, engineers, and practitioners in the art who are not familiar with patent or art terminology or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

The embodiments described herein relate to a device that is an additive between the standalone Scooter platform, or substrate, and an added enhanced platform with balancing wheels. This provides a larger enhanced Scooter platform that is affixed to the standard or e-battery platform for the purpose of reducing the balance required to ride the scooter, thus increasing the safety of the less skilled in this field. In particular, the augmentation and the substrate between the front and back tires are for the purpose of security and balance for the end user. The augmented structure is positioned and tightened on to the carriage, or the scooter platform to increase stability and standing surface area. The ergo platform of the ergo stabilizing device is larger in comparison to the scooter platform. By adding a larger platform with wheels extending wider than the Scooter platform the user will have an increase sense of the equilibrium effect while operating the Scooter. Preferably the attachment wheels are connected by a suspension system allowing the wheels to travel up and down for example if a bump or hole is encountered

In a preferred embodiment, the ergo stabilizing device has an ergo platform that is configured to connect to the platform of the prior art scooter. An attachment mechanism is provided to connect the platform via clamping, bolt, toggle, or any method by which the ergo platform would attach to the Scooter's platform.

The top side of the Scooter's platform is preferably longer than wide preferably with a radius on each corner, with the length being the distance of the platform that extends in the same axis as the length of the scooter from wheel to wheel. It may be noted that the ergo platform may be configured in any geometric design. The prior art Scooter's platform may be electric, manual, or any other type of stored energy that causes the user and Scooter to accelerate.

The ergo platform is configured to securely connect to the prior art scooter platform. The added ergo platform has two opposing wheels that extend downward from the platform. The wheels are connected to the platform by a suspension system that allows the wheels to move vertically relative to the platform. This suspension system adds stability to the Scooter and keeps it upright. The ergo platform also increases width when placed up on the Scooter's platform.

The ergo platform is configured to be placed on top of the substrate of the Scooter such that each bottom side of the ergo platform rests on the top side of the scooter platform.

The scooter platform and ergo platform are retained together (connected) by via bolt, clamp, glue, and/or or any compound to attach temporarily or permanently.

The platform of the Scooter comprises of two lateral peripheral edges on opposite sides of the scooter platform. In a preferred embodiment the ergo platform is clamped to the two peripheral edges of the scooter platform. The ergo platform embodiment has an open face, a top side, and a bottom side. The bottom side is configured seat on the Scooter's platform and augment the scooter's platform when attached to the scooter. The bottom side may have an adjustable guide slot or hole for a bolt or clamping device to secure the ergo platform on to the scooter platform. A guide slot may be configured to engage and secure the peripheral end of the Scooter's platform and position the ergo platform and scooter platform together substantially before locking in position.

The standalone ergo platform includes wheels that extend downward and are positioned wider than the wheels of the scooter. The attachment wheels are preferably configured such that when there is no rider weight on the attachment and scooter, the scooter wheels are positioned on the ground or floor, and the wheels of the attachment are approximately one to three millimeters (1-3 mm) above the ground or floor. The weight of the rider causes the scooter platform and ergo platform to depress, causing the attachment wheels to travel on the ground or floor when a rider is on the combined attachment and scooter. The attachment wheels are preferably connected directly or indirectly to the attachment platform by shocks, or adjustable shocks to stabilize the entire Scooter and attachment once attached.

The wheel may be placed anywhere under the augmented standalone platform. There may be one or more wheels anywhere under the augmented standalone platform.

Still other features and advantages of the presently disclosed and claimed inventive concept(s) will become readily apparent to those skilled in this art from the following detailed description describing preferred embodiments of the inventive concept(s), simply by way of illustration of the best mode contemplated by conducting the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 illustrates a top perspective view of an embodiment of a prior art E-Scooter.

FIG. 2 illustrates a front perspective view of an embodiment of a prior art E-Scooter.

FIG. 3 illustrates a side perspective view of an embodiment of a prior art E-Scooter.

FIG. 4 illustrates an isometric perspective view of an embodiment of a prior art E-Scooter.

FIG. 5 illustrates a top perspective view of an embodiment of an ergo platform attachment for an E-Scooter.

FIG. 6 illustrates a front perspective view of an embodiment of an ergo platform attachment for an E-Scooter.

FIG. 7 illustrates a side perspective view of an embodiment of an ergo platform attachment for an E-Scooter.

FIG. 8 illustrates an iso perspective view of an embodiment of an ergo platform attachment for an E-Scooter.

FIG. 9 illustrates a top perspective view of an embodiment of an ergo platform attachment attached to a Scooter.

FIG. 10 illustrates a front perspective view of an embodiment of an ergo platform attachment for an E-Scooter, and an E-Scooter combined.

FIG. 11 illustrates a side perspective view of an embodiment of an ergo platform attachment for an E-Scooter, and an E-Scooter combined.

FIG. 12 illustrates an iso perspective view of an embodiment of an ergo platform attachment for an E-Scooter, and an E-Scooter combined.

FIG. 13 illustrates a bottom perspective view of an embodiment of an ergo platform attachment for an E-Scooter, and an E-Scooter combined.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood however, that there is no intention to limit the inventive concept(s) to the specific form disclosed, but, on the contrary the presently disclosed and claimed inventive concept(s) is to cover all modifications, alternative constructions, and equivalents falling within the spirit and scope of the inventive concept(s) as defined in the claims.

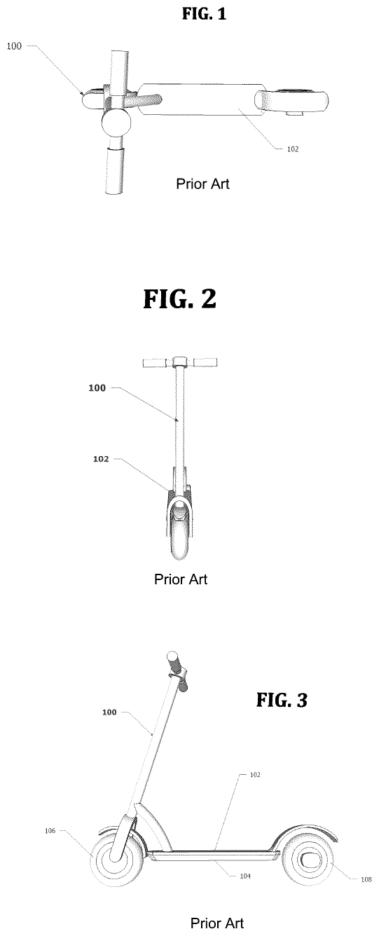

FIG. 1 illustrates the top perspective of an embodiment of an E-Scooter 100 that has an open scooter platform 102 that extends between the front and back wheel of the Scooter. The platform 102 can be a battery, gas, or manual substrate for the user to stand on.

FIG. 2 illustrates a front perspective of an embodiment of an E-Scooter 100. The platform 102, extends between the front and rear tire, and is for the purpose of a standing platform. The platform 102 can be a battery, or any substrate that stores kinetic energy for the purpose of propelling.

FIG. 3 illustrates a side perspective of an embodiment of an E-Scooter 100. Depicted is the platform 102 for standing, and the undercarriage of the platform 104. The ergo platform 102 can be made of metal, plastic, fiber, or any material recommended for strength. Like any form of transportation, the front wheel 106, and back wheel 108 are standard necessary parts for movement.

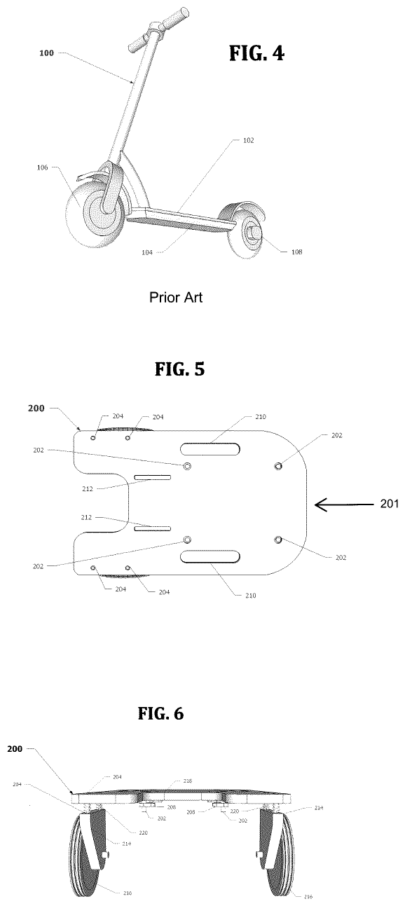

FIG. 4 illustrates an isometric perspective of an embodiment of an E-Scooter 100. Again, depicted if the scooter platform 102, and the undercarriage 104 of the scooter platform. Again, the front wheel 106, and back wheel 108 are depicted in FIG. 4.

FIG. 5 illustrates the top perspective of an embodiment of an ergo platform attachment 200 that serves to provide a stabilized scooter platform on which the rider stands, and can connect to a seat for sitting while in transport. The ergo platform 201 is clamped on the scooter platform 102 by the clamping action provided by bolts 2002 in association with tabs 208. A seat bar base may be clamped, glued, bolted, or any other methodology to secure the seat base from moving, preferably to the slots 212. Slots 210 may also be added to help carry or maneuver ergo platform to the Scooter 100. Bolts 202 extend through the ergo platform 201 with vertically adjustable tabs 208 which clamp to the peripheral edge of the scooter platform to secure the attachment to the scooter platform. Two wheels 216 extend downward from the ergo platform and are connected to the platform by suspension system 220. held to the Scooter attachment via bolts 204 to provide stability for the rider.

FIG. 6 illustrates the front perspective of an Scooter attachment 200. As depicted in this perspective are two wheels 216 that are supported by a plate 214, that are attached to the top part of the platform 218 via bolts 204. Shock absorbers 220 are added to absorb the shock while riding. It may be noted that springs or any other methodology of absorbing shock may be used for this purpose.

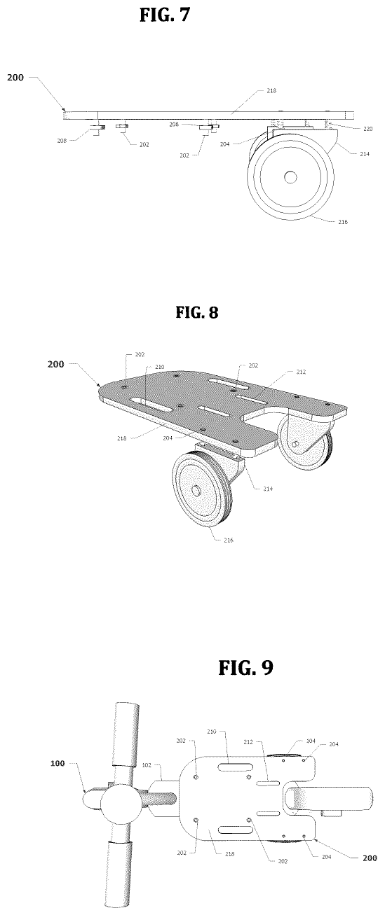

FIG. 7 illustrates the side perspective of an Scooter attachment 200. This view depicts the clamps 208 attached to the bolts 202 for the purpose of securing the Scooter attachment to the Scooter. There may be 1 or more clamps used for this purpose. The clamp bolts 202, and wheel bolts 204, intersect the top platform 218 of the Scooter attachment 200. Again, depicted are the wheels 216 that attach to support plate 214, that receive a bolt 204 with a biasing spring 220 for absorbing shock. It may be noted that the surface area of the bolt 204 may be smooth to allow the spring 220 to function.

FIG. 8 illustrates the isometric perspective of an Scooter attachment 200. As shown in FIG. 8 are the clamp bolts 202 and wheel bolts 204 intersecting the top platform 218 of the Scooter attachment 200. Also depicted, transportation slots 210 may be added for easy maneuverability to and from Scooter. The seat base attaches to the slots 212 provided for clamping a seat to the Scooter attachment 200. A seat may attach to Scooter attachment 200 via clamp, bolt, glue, weld, or any methodology for the purpose of securing the Scooter attachment 200 to the Scooter 100. Again, two wheels 216 attach to a support plate 214, which attaches to the bolt 204 which attaches and intersects with the top plate 218 of the Scooter attachment 200.

FIG. 9 illustrates the top perspective of an Scooter attachment 200 attached to an E-Scooter 100. The platform 102 of the E-Scooter 100 is considered the substrate for the Scooter attachment 200 for illustrative purposes only. From the top view it is shown that there are through slots 210 for easy gripping and transporting. Depicted are bolts 202 for holding clamps 208 (FIG. 7) to Scooter platform 102. Also depicted are four bolts to secure the wheels to the top platform 201. Through hole slots 212 is illustrated for the purpose of securing a seat base (not shown) to the Scooter attachment 200.

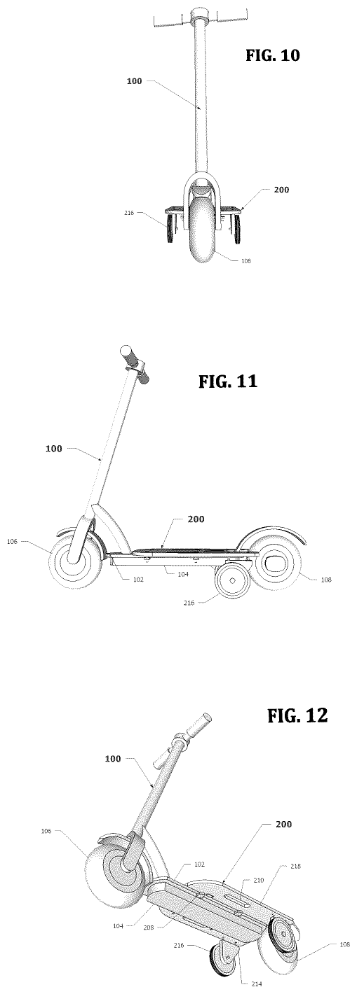

FIG. 10 illustrates the front view of a Scooter 100 and the Scooter attachment 200 attached thereto. The front wheel 108 of the Scooter 100 is shown distinctively in this perspective. Also, the Scooter attachment 200 wheels 216 are shown and used to keep the Scooter 100 upright and stable for the rider.

FIG. 11 illustrates the side perspective of the Scooter 100 and the Scooter attachment 200. The front wheel 106 and the back wheel 108 are depicted on the Scooter 100. Also depicted in this perspective are wheels on the Scooter attachment 200, 216. The platform 102 of the Scooter 100, is the substrate for the Ergo Stability Platform 200 to attach to. Also, depicted in FIG. 11 is the undercarriage 104 of the platform 102 of the Scooter 100. The undercarriage 104 can be a battery or any supportive substrate to accept the rider and/or Scooter attachment 200.

FIG. 12 illustrates the isometric perspective of the E-Scooter 100, and the Scooter attachment 200 attached together via clamps 208. The Scooter attachment 200 may attach with clamps 208, bolts, weld, glue or by any methodology to hold the Scooter 100 and Scooter attachment 200 securely together. Again, depicted in FIG. 12 is the front wheel 106, the back wheel 108 of the E-Scooter 100. The wheels 216 on the Scooter attachment 200 are also depicted from this perspective. The platform 102 and undercarriage 104, between the wheels 106, 108 are part of the E-Scooter 100 for support for the rider and the Scooter attachment 200. Through hole slot 210 of top plate 218 of Scooter attachment 200 is illustrated in the isometric perspective of FIG. 12.

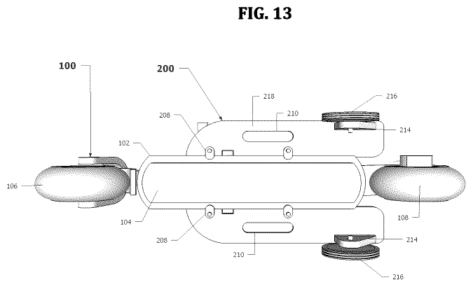

FIG. 13 illustrates the bottom perspective of the combined E-Scooter 100, and the Scooter attachment 200. The front wheel 106, and the back wheel 108 are depicted pronouncedly as part of the E-Scooter 100. Also depicted are two wheels 216 attached to the Scooter attachment 200 via wheel support frames 214. The platform 102, and undercarriage 104 of the platform 102, are illustrated as part of the standalone E-Scooter 100. FIG. 13 shows the combined embodiments of the E-Scooter 100, and the Scooter attachment 200, clamped together with one or more clamps 208, for purposes of securing the two embodiments together. Again, depicted in FIG. 13 is through hole slots 210, through the top platform 218 of embodiment 200, for easy maneuverability and transport.

While certain preferred embodiments are shown in the figures and described in this disclosure, it is to be distinctly understood that the presently disclosed inventive concept(s) is not limited thereto but may be variously embodied to the practice within the scope of the following claims. From the foregoing description, it will be apparent that various changes may be made without departing from the spirit and scope of the disclosure as defined by the following claims.

I claim:

1. An ergo platform device for a scooter, said scooter comprising a front wheel and a back wheel with a scooter platform extending between said front wheel and said back wheel, said ergo platform device comprising:
An ergo platform configured for mounting on top of said scooter platform, wherein said ergo platform is wider than said scooter platform and configured for a user to stand on said ergo platform when said ergo platform is mounted on top of said scooter platform;
Two opposing wheels connected to said ergo platform and extending beneath said ergo platform; and
Wherein said ergo platform is configured for attaching to said scooter platform such that said wheels are positioned outside of said wheels of said scooter to provide stability to said scooter.

2. The ergo platform device for a scooter of claim 1 wherein said ergo platform comprising at least one clamping arm wherein said clamping arm is configured to attach to a scooter to secure the ergo stability platform to said top surface of the scooter platform.

3. The ergo platform device of claim 1 further comprising shock absorbers between said wheels and said ergo platform.

4. The ergo platform device of claim 1 wherein said ergo platform is configured for removable attachment onto the scooter platform.

5. The ergo platform is configured such that when said.

6. The ergo platform device of claim 1 wherein said Scooter attachment and said scooter are configured for combining as one unit.

7. The ergo platform device of claim 4, wherein said Scooter attachment and scooter are configured for attachment by a clamping device.

8. The ergo platform device of claim 5, wherein said Scooter attachment comprises said clamp or hold device wherein said clamp attaches to scooter along a perimeter of said scooter.

9. The ergo platform device of claim 5, wherein the platform comprises a mounting slot(s), wherein slot(s) is to accept a seat base.

10. The ergo platform device of claim 7, wherein the platform comprises a bolting system that attaches wheel(s) to Scooter attachment.

11. The ergo platform device of claim 8, wherein the platform comprises of through hole slots for maneuverability of Scooter attachment.

12. The ergo platform device of claim 1, wherein the Scooter attachment is configured to connect to said scooter platform by bolting, gluing, welding, and/or clamping.
